(19) United States
(12) Patent Application Publication
(10) Pub. No.: US 2023/0361346 A1
(43) Pub. Date: Nov. 9, 2023

(54) COMPOSITION

(71) Applicant: Mexichem Fluor S.A. de C.V., San Luis Potosi (MX)

(72) Inventors: Andrew Sharratt, Runcorn (GB); Ira Saxena, Runcorn (GB)

(21) Appl. No.: 18/044,835

(22) PCT Filed: Sep. 9, 2021
(86) PCT No.: PCT/GB2021/052334

§ 371 Date: Mar. 10, 2023

(30) Foreign Application Priority Data
Sep. 17, 2020 (GB) 2014633.8
Feb. 22, 2021 (GB) 2102464.1

(51) Int. Cl. H01M 10/0567; H01M 10/0568; H01M 10/0569; H01M 4/38

(52) U.S. Cl. CPC H01M 10/0567; H01M 10/0568; H01M 10/0569; H01M 4/382; H01M 2004/027

(57) ABSTRACT

Use of a formulation comprising a metal ion and a compound of Formula 1 in a nonaqueous battery electrolyte formulation wherein R¹, R², R³, R⁴ are independently selected from the group comprising H, F, Cl, Br, I, CF₃, alkyl, fluoroalkyl, haloalkyl and R⁵ is independently selected from the group CF₃, alkyl, fluoroalkyl, perfiuoroalkyl, haloalkyl perfluorohaloalkyl.

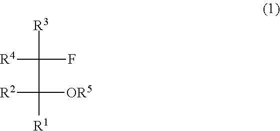

### COMPOSITION

The present disclosure relates to nonaqueous electrolytic solutions for energy storage devices including batteries and capacitors, especially for secondary batteries and devices known as supercapacitors.

There are two main types of batteries: primary and secondary. Primary batteries are also known as non-rechargeable batteries. Secondary batteries are also known as rechargeable batteries. A well-known type of rechargeable battery is the lithium-ion battery Lithium-ion batteries have a high energy density, no memory effect and low self-discharge..

Lithium-ion batteries are commonly used for portable electronics and electric vehicles. In the batteries lithium ions move from the negative electrode to the positive electrode during discharge and back when charging.

Typically, the electrolytic solutions include a nonaqueous solvent and an electrolyte salt, plus additives. The electrolyte is typically a mixture of organic carbonates such as ethylene carbonate, propylene carbonate, fluoroethylene carbonate, dialkyl carbonates such as ethyl methyl carbonate and ethers and polyethers such as dimethoxyethane containing a lithium-ion electrolyte salt. Many lithium salts can be used as the electrolyte salt; common examples include lithium hexafluorophosphate (LiPF₆), lithium bis (fluorosulfonyl) imide (LiFSI) and lithium bis(trifluoromethanesulfonyl)imide (LiTFSI).

The electrolytic solution has to perform a number of separate roles within the battery.

The principal role of the electrolyte is to facilitate the flow of charge carriers between the cathode and anode. This occurs by transportation of metal ions within the battery to or from one or both of the anode and cathode, whereby on chemical reduction or oxidation, electrical charge is liberated/adopted.

Thus, the electrolyte needs to provide a medium which is capable of solvating and/or supporting the metal ions.

Due to the use of lithium electrolyte salts and the interchange of lithium ions with lithium metal, which is very reactive with water, as well as the sensitivity of other battery components to water, the electrolyte is usually non-aqueous.

Additionally, the electrolyte has to have suitable rheological properties to permit/enhance the flow of ions therein, at the typical operating temperature to which a battery is exposed and is expected to perform.

Moreover, the electrolyte has to be as chemically inert as possible. This is particularly relevant in the context of the expected lifetime of the battery regarding internal corrosion within the battery (e.g. of the electrodes and casing) and the issue of battery leakage. Also of importance within the consideration of chemical stability is flammability. Unfortunately, typical electrolyte solvents can be a safety hazard, since they often comprise a flammable material.

This can be problematic as in operation, when discharging or being discharged, batteries may accumulate heat. This is especially true for high density batteries such as lithium-ion batteries. It is therefore desirable that the electrolyte displays a low flammability, with other related properties such as a high flash point.

It is also desirable that the electrolyte does not present an environmental issue with regard to disposability after use or other environmental issue such as global warming potential.

“Regioselectivity in addition reactions of some binucleophilic reagents to (trifluoromethyl) acetylene” Stepanova et. al., Zhurnal Organicheskoi Khimii (1988), 24(4), 692-9 describes the preparation of a dioxolane having a CF₃CH₂ group, at relatively low levels of selectivity.

The listing or discussion of an independently prior published document in this specification should not necessarily be taken as an acknowledgement that the document is part of the state of the art or is common general knowledge.

It is an object of the present invention to provide a nonaqueous electrolytic solution, which provides improved properties over the nonaqueous electrolytic solution of the prior art.

### Use Aspects

According to a first aspect of the invention there is provided the use of a formulation comprising a metal ion and a compound of Formula 1 in a nonaqueous battery electrolyte formulation,

According to a second aspect of the invention there is provided the use of a nonaqueous battery electrolyte formulation comprising a formulation comprising a metal ion and a compound of Formula 1 in a battery.

### Composition/Device Aspects

According to a third aspect of the invention there is provided a battery electrolyte formulation comprising a formulation comprising a metal ion and a compound of Formula 1.

According to a fourth aspect of the invention there is provided a formulation comprising a metal ion and a compound of Formula 1, optionally in combination with a solvent.

According to a fifth aspect of the invention there is provided a battery comprising a battery electrolyte formulation comprising a metal ion and a compound of Formula 1.

### Method Aspects

According to a sixth aspect of the invention there is provided a method of reducing the flash point of a battery and/or a battery electrolyte formulation, comprising the addition of a formulation comprising a formulation comprising a metal ion and a compound of Formula 1.

According to a seventh aspect of the invention there is provided a method of powering an article comprising the use of a battery comprising a battery electrolyte formulation comprising a formulation comprising a metal ion and a compound of Formula 1.

According to an eighth aspect of the invention there is provided a method of retrofitting a battery electrolyte formulation comprising either (a) at least partial replacement of the battery electrolyte with a battery electrolyte formulation comprising a formulation comprising a metal ion and a compound of Formula 1, and/or (b) supplementation of the battery electrolyte with a battery electrolyte formulation comprising a compound of Formula 1.

According to a ninth aspect of the invention there is provided a method of preparing a battery electrolyte formulation comprising mixing a compound of Formula 1 with a metal ion containing salt and other solvents or co-solvents.

According to a tenth aspect of the invention there is provided a method of preparing a battery electrolyte formulation comprising mixing a composition comprising a compound of Formula 1 with a metal ion-containing compound,

According to an eleventh aspect of the invention there is provided a method of improving battery capacity/charge transfer within a battery/battery life/etc. by the use of a formulation comprising a metal ion and a compound of Formula 1.

According to a twelfth aspect of the invention there is provided a method of reducing the overpotential generated at one or both of the electrodes of a battery during cycling by the use of a formulation comprising a metal ion and a compound of Formula 1.

### Compound of Formula

In reference to all aspects of the invention the preferred embodiment of Formula (1) is a partially fluorinated ether with the structure

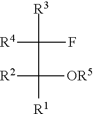

wherein R¹, R², R³, R⁴ are independently selected from the group comprising H, F, Cl, Br, I, CF₃, alkyl, fluoroalkyl, haloalkyl and R⁵ is independently selected from the group CF₃, alkyl, fluoroalkyl, perfluoroalkyl, haloalkyl perfluorohaloalkyl.

Most preferably R⁵ methyl; preferably R¹ and R² are CF₃ and R³ and R⁴ are H; alternatively R¹ is CF₃, R² is H, one of R³ and R⁴ is F, and one of R³ and R⁴ is H; further alternatively R¹ is CF₃, R² is H. and R³ and R⁴ are H.

### Advantages

In the aspects of the invention, the electrolyte formulation has been found to be surprisingly advantageous.

The advantages of using formulations comprising compounds of Formula 1 in electrolyte solvent compositions manifest themselves in a number of ways. Their presence can reduce the flammability of the electrolyte composition (such as when for example measured by flashpoint). Their oxidative stability makes them useful for batteries required to work in harsh conditions and at high temperatures, they are compatible with common electrode chemistries and can even enhance the performance of these electrodes through their interactions with them.

Additionally, electrolyte compositions comprising compounds of Formula 1 may have superior physical properties including low viscosity and a low melting point, yet a high boiling point with the associated advantage of little or no gas generation in use. The electrolyte formulation may wet and spread extremely well over surfaces, particularly fluorine-containing surfaces; this is postulated to result from a beneficial a relationship between its adhesive and cohesive forces, to yield a low contact angle.

Furthermore, electrolyte compositions that comprise compounds of Formula 1 may have superior electro-chemical properties, including improved capacity retention, reduced overpotential generation at one or both electrodes during cycling, improved cyclability and capacity retention, improved compatibility with other battery components e.g. separators and current collectors, and with all types of cathode and anode chemistries, including systems that operate across a range of voltages and especially high voltages, and which include additives such as silicon. In addition, the electrolyte formulations display good solvation of metal (e.g. lithium) salts and interaction with any other electrolyte solvents present.

Preferred features relating to the aspects of the invention follows below. Preferences and options for a given aspect, feature or parameter of the invention should, unless the context indicates otherwise, be regarded as having been disclosed in combination with any and all preferences and options for all aspects, features and parameters of the invention.

### Electrolyte Formulation

The electrolyte formulation will preferably comprise 0.1 wt % to 99.9 wt % of the compound of Formula 1, conveniently 50.0 wt % to 99.9 wt % of the compound of Formula 1.

### Metal Salts

The nonaqueous electrolytic solution further comprises a metal ion, Normally the metal ion comes from an ionic salt, such as a metal electrolyte salt. Typically the metal electrolyte salt is present in an amount of 0.1 to 90 wt % relative to the total mass of the nonaqueous electrolyte formulation depending on the application.

The metal salt generally comprises a salt of lithium, sodium, magnesium, calcium, lead, zinc, ammonium or nickel. (Here it is of course appreciated that “ammonium” is not a metal per se. However, ammonium is a cation and can form ionic salts that can act as electrolyte salts.

Preferably the metal salt comprises a salt of lithium, such as those selected from the group comprising lithium hexafluorophosphate (LiPF₆), lithium hexafluoroarsenate monohydrate (LiAsF₆), lithium perchlorate (LiClO₄), lithium tetrafluoroborate (LiBF₄), lithium triflate (LiSO₃CF₃), lithium bis(fluorosulfonyl)imide (LiFSI, Li(FSO₂)₂N) and lithium bis(trifluoromethanesulfonyl)imide (LiTFSI, Li(CF₃SO₂)₂N).

Most preferably, the metal salt comprises LiPF₆, LiFSI or LiTFSI. Thus, in a most preferred variant of the fourth aspect of the invention, there is provided a formulation comprising LiPF₆, LiFSI, LiTFSI and a compound of Formula 1, optionally in combination with one or more co-solvents.

Alternatively the metal salt comprises a salt of ammonium. Most preferably ammonium refers to NH₄⁺ quaternary ammonium cations or alternatively NH₄₋ₓRₓ⁺, where one or more hydrogen atoms are replaced by organic groups (indicated by R). Preferred examples of organic groups include C₁-C₂₀ alkyl, fluoroalkyl, perfluoroalkyl, haloalkyl perfluorohaloalkyl. Particularly preferred is tetraethyl ammonium.

Preferred ammonium salts include fluoroborates such as tetrafluoroborates, such as BF₄⁻.

### Solvents

The nonaqueous electrolytic solution may comprise a solvent. Preferred examples of solvents include fluoroethylene carbonate (FEC) and/or propylene carbonate (PC), dimethyl carbonate (DMC), ethyl methyl carbonate (EMC), ethylene carbonate (EC),dimethoxyethane (DME), dioxolane (DOL) or acetonitrile.

Where present, the additional solvent makes up from 0.1 wt % to 99.9 wt % of the liquid component of the electrolyte.

### Additives

The nonaqueous electrolytic solution may include an additive.

Suitable additives may serve as surface film-forming agents, which form an ion permeable film on the surface of the positive electrode or the negative electrode. This can pre-empt a decomposition reaction of the nonaqueous electrolytic solution and the electrolyte salt occurring on the surface of the electrodes, thereby preventing the decomposition reaction of the nonaqueous electrolytic solution on the surface of the electrodes.

Examples of film-forming agent additives include vinylene carbonate (VC), ethylene sulfite (ES), lithium bis(oxalato)borate (LiBOB), cyclohexylbenzene (CHB) and ortho-terphenyl (OTP). The additives may be used singly, or two or more may be used in combination.

When present, the additive is present in an amount of 0.1 to 3 wt % relative to the total mass of the nonaqueous electrolyte formulation.

### Battery

### Primary/Secondary Battery

The battery may comprise a primary (non-rechargeable) or a secondary battery (rechargeable). Most preferably the battery comprises a secondary battery.

A battery comprising the nonaqueous electrolytic solutions will generally comprise several elements. Elements making up the preferred nonaqueous electrolyte secondary battery cell are described below. It is appreciated that other battery elements may be present (such as a temperature sensor); the list of battery components below is not intended to be exhaustive.

### Electrodes

The battery generally comprises a positive and a negative electrode. Usually the electrodes are porous and permit metal ions (lithium ions) to move in and out of their structures with a process called insertion (intercalation) or extraction (deintercalation).

For rechargeable batteries (secondary batteries), the term cathode designates the electrode where reduction is taking place during the discharge cycle. For lithium-ion cells the positive electrode (“cathode”) is the lithium-based one.

### Positive Electrode (Cathode)

The positive electrode is generally composed of a positive electrode current collector such as a metal foil, optionally with a positive electrode active material layer disposed on the positive electrode current collector.

The positive electrode current collector may be a foil of a metal that is stable at a range of potentials applied to the positive electrode, or a film having a skin layer of a metal that is stable at a range of potentials applied to the positive electrode, Aluminium (Al) is desirable as the metal that is stable at a range of potentials applied to the positive electrode.

The positive electrode active material layer generally includes a positive electrode active material, and other components such as a conductive agent and a binder. This is generally obtained by mixing the components in a solvent, applying the mixture onto the positive electrode current collector, followed by drying and rolling.

The positive electrode active material may be lithium (Li) or a lithium-containing transition metal oxide. The transition metal element may be at least one selected from the group consisting of scandium (Sc), manganese (Mn), iron (Fe), cobalt (Co), nickel (Ni), copper (Cu) and yttrium (Y). Of these transition metal elements, manganese, cobalt and nickel are the most preferred.

Further, in certain embodiments transition metal fluorides may be preferred.

Some of the transition metal atoms in the transition metal oxide may be replaced by atoms of a non-transition metal element. The non-transition element may be selected from the group consisting of magnesium (Mg), aluminium (Al), lead (Pb), antimony (Sb) and boron (B). Of these non-transition metal elements, magnesium and aluminium are the most preferred.

Preferred examples of positive electrode active materials include lithium-containing transition metal oxides such as LiCoO₂, LiNiO₂, LiMn₂O₄, LiMnO₂, LiNi_{1-y}Co_{y}O₂ (0<y<1), LiNi_{1-y-z} Co_{y}Mn_{z}O₂ (0<y+z<1) and LiNi_{1-y-z}Co_{y}Al_{z}O₂ (0<y+z<1). LiNi_{1-y-z}Co_{y}Mn_{z}O₂ (0<y+z<0.5) and LiNi_{1-y-z}Co_{y}AlO₂ (0<y+z<0.5) containing nickel in a proportion of not less than 50 mol % relative to all the transition metals are desirable from the perspective of cost and specific capacity. These positive electrode active materials contain a large amount of alkali components and thus accelerate the decomposition of nonaqueous electrolytic solutions to cause a decrease in durability. However, the nonaqueous electrolytic solution of the present disclosure is resistant to decomposition even when used in combination with these positive electrode active materials.

The positive electrode active material may be a lithium (Li) containing transition metal fluoride. The transition metal element may be at least one selected from the group consisting of scandium (Sc), manganese (Mn), iron (Fe), cobalt (Co), nickel (Ni), copper (Cu) and yttrium (Y). Of these transition metal elements, manganese, cobalt and nickel are the most preferred.

Some of the transition metal atoms in the transition metal fluoride may be replaced by atoms of a non-transition metal element. The non-transition element may be selected from the group consisting of magnesium (Mg), aluminium (Al), lead (Pb), antimony (Sb) and boron (B). Of these non-transition metal elements, magnesium and aluminium are the most preferred.

A conductive agent may be used to increase the electron conductivity of the positive electrode active material layer. Preferred examples of the conductive agents include conductive carbon materials, metal powders and organic materials. Specific examples include carbon materials as acetylene black, ketjen black and graphite, metal powders as aluminium powder, and organic materials as phenylene derivatives.

A binder may be used to ensure good contact between the positive electrode active material and the conductive agent, and to increase the adhesion of the components such as the positive electrode active material with respect to the surface of the positive electrode current collector. Preferred examples of the binders include fluoropolymers and rubber polymers, such as polytetrafluoroethylene (PTFE), polyvinylidene fluoride (PVdF) ethylene-propylene-isoprene copolymer and ethylene-propylene-butadiene copolymer. The binder may be used in combination with a thickener such as carboxymethylcellulose (CMC) or polyethylene oxide (PEO).

### Negative Electrode (Anode)

The negative electrode is generally composed of a negative electrode current collector such as a metal foil, optionally with a negative electrode active material layer disposed on the negative electrode current collector.

The negative electrode current collector may be a foil of a metal, Copper (lithium-free) is suitable as the metal. Copper is easily processed at low cost and has good electron conductivity.

Generally, the negative electrode comprises carbon, such as graphite or graphene and/or lithium metal, In preferred embodiments, the negative electrode comprises graphite and/or lithium metal.

Silicon based materials can also be used for the negative electrode. A preferred form of silicon is in the form of nano-wires, which are preferably present on a support material. The support material may comprise a metal (such as steel) or a non-metal such as carbon.

The negative electrode may include an active material layer, Where present the active material layer includes a negative electrode active material and other components such as a binder. This is generally obtained by mixing the components in a solvent, applying the mixture onto the positive electrode current collector, followed by drying and rolling.

Negative electrode active materials are not particularly limited, provided the materials can store and release lithium ions. Examples of suitable negative electrode active materials include carbon materials, metals, alloys, metal oxides, metal nitrides, and lithium-intercalated carbon and silicon, Examples of carbon materials include natural/artificial graphite, and pitch-based carbon fibres. Preferred examples of metals include lithium (Li), silicon (Si), tin (Sn), germanium (Ge), indium (In), gallium (Ga), titanium (Ti), lithium alloys, silicon alloys and tin alloys. Examples of lithium-based material include lithium titanate (Li2TiO3).

The active material may can be in many forms such as a thin film, foil or supported on a three-dimensional matrix.

As with the positive electrode, the binder may be a fluoropolymer or a rubber polymer and is desirably a rubbery polymer, such as styrene-butadiene copolymer (SBR). The binder may be used in combination with a thickener.

In a preferred embodiment, the negative electrode is lithium metal, in a secondary battery; conveniently in such embodiments, but also in other embodiments with other negative electrodes and in other battery types, the electrolyte comprises LiTFSI and/or LiFSI, dimethoxyethane, and a compound of Formula 1.

### Separator

A separator is preferably present between the positive electrode and the negative electrode. The separator has insulating properties. The separator may comprise a porous film having ion permeability. Examples of porous films include microporous thin films, woven fabrics and nonwoven fabrics. Suitable materials for the separators are polyolefins, such as polyethylene and polypropylene.

### Case

The battery components are preferably disposed within a protective case.

The case may comprise any suitable material which is resilient to provide support to the battery and an electrical contact to the device being powered,

In one embodiment the case comprises a metal material, preferably in sheet form, moulded into a battery shape. The metal material preferably comprises a number of portions adaptable be fitted together (e.g. by push-fitting) in the assembly of the battery. Preferably the case comprises an iron/steel-based material.

In another embodiment the case comprises a plastics material, moulded into a battery shape. The plastics material preferably comprises a number of portions adaptable be joined together (e.g. by push-fitting/adhesion) in the assembly of the battery. Preferably the case comprises a polymer such as polystyrene, polyethylene, polyvinyl chloride, polyvinylidene chloride, or polymonochlorofluoroethylene. The case may also comprise other additives for the plastics material, such as fillers or plasticisers. In this embodiment wherein the case for the battery predominantly comprises a plastics material, a portion of the casing may additionally comprise a conductive/metallic material to establish electrical contact with the device being powered by the battery.

### Arrangement

The positive electrode and negative electrode may be wound or stacked together through a separator. Together with the nonaqueous electrolytic solution they are accommodated in the exterior case. The positive and negative electrodes are electrically connected to the exterior case in separate portions thereof.

### Module/Pack

A number/plurality of battery cells may be made up into a battery module. In a battery module the battery cells may be organised in series and/or in parallel. Typically, these are encased in a mechanical structure.

A battery pack may be assembled by connecting multiple modules together in a series or parallel. Typically, battery packs include further features such as sensors and controllers including battery management systems and thermal management systems. The battery pack generally includes an encasing housing structure to make up the final battery pack product.

### End Uses

The battery of the invention, in the form of an individual battery/cell, module and/or pack (and the electrolyte formulations therefor) are intended to be used in one or more of a variety of end products.

Preferred examples of end products include portable electronic devices, such as GPS navigation devices, cameras laptops, tablets and mobile phones. Other preferred examples of end products include vehicular devices (as provision of power for the propulsion system and/or for any electrical system or devices present therein), such as electrical bicycles and motorbikes, as well as automotive applications (including hybrid and purely electric vehicles).

Preferences and options for a given aspect, feature or parameter of the invention should, unless the context indicates otherwise, be regarded as having been disclosed in combination with any and all preferences and options for all other aspects, features and parameters of the invention.

The invention will now be illustrated with reference to the following non-limiting examples.

### EXAMPLES

### Example 1a—Ring Opening of 2,3-Epoxy-1,1,1-Trifiuoropropane with Olah's Reagent

The following steps were followed.
The reactor was charged with Olah's reagent (70% HF:Pyridine, 5 ml) and cooled in an ice batch with stirring.
2,3-epoxyl,1,1-trifluoropropane (TFPO) (3.4 g) was then added dropwise.
At the end of the addition the reaction mixture was allowed to warm up to room temperature. Stirring was continued for 48 hours.
After 48 hours the reaction mixture was quenched with ice.
Salt was added, and the product extracted with diethyl ether (3×5 ml). The diethyl ether extracts were combined, washed with saturated potassium bicarbonate solution and water before being dried over anhydrous sodium sulphate. Diethyl ether was removed in vacuo to yield the desired product as a clear, colourless liquid boiling point 91-93° C. The identity of this product was confirmed by NMR spectroscopy.

### Example 1b—Ring Opening of 2,3-Epoxy-1,1,1,3-Tetrafluoropmpane with Olah's Reagent

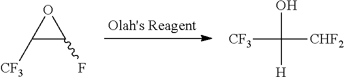 [SMILES: FC1OC1C(F)(F)F ; OC(C(F)F)C(F)(F)F]

2,3-epoxy-1,1,1,3-tetrafluoropropane was ring opened using the following procedure:
A 100 ml Hastalloy C pressure reactor was charged with Olah's reagent (70% HF:Pyridine, 25 g).
After sealing, the contents of the reactor were cooled to 20° C. with stirring.
2,3-epoxy-1,1,1,3-tetrafluoropropane (11 g) was then added.
After this addition was complete the reaction mixture was heated to 50° C. and stirred for 168 hours.
After 168 hours the reaction mixture was quenched with ice and saturated sodium chloride solution (22 ml) added.
The product was extracted from this mixture with diethyl ether.
The diethyl ether extracts were combined, washed with saturated potassium bicarbonate solution and then water before being dried over anhydrous sodium sulphate. The identity of the product was confirmed by NMR spectroscopy.

### Example 1c—Ring Opening of 2,3-Epoxy-1,1,1,3-Tetrafluoropropane with Olah's Reagent

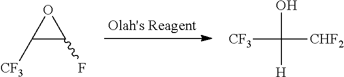 [SMILES: FC1OC1C(F)(F)F ; OC(C(F)F)C(F)(F)F]

2,3-epoxy-1,1,1,3-tetrafluoropropane was ring opened using the following procedure:
A 100 ml Hastalloy C pressure reactor was charged with Olah's reagent (70% HF:Pyridine. 25 g).
After sealing, the contents of the reactor were cooled to 20° C. with stirring.
2,3-epoxy-1,1,1,3-tetrafluoropropane (10.6 g) was then added.
After this addition was complete the reaction mixture was heated to 80° C. and stirred for 43 hours.
After 43 hours a sample of the reaction mixture was analysed by GCMS and it was found that all the feed epoxide had reacted.
After cooling the reaction mixture was quenched with ice and saturated sodium chloride solution (22 ml) added.
The product was extracted from this mixture with diethyl ether.
The diethyl ether extracts were combined, washed with saturated potassium bicarbonate solution and then water before being dried over anhydrous sodium sulphate. The identity of the product was confirmed by NMR spectroscopy.

### Example 2—Ring Opening of 2,3-Epoxy-1,1,1-Trifluoro-2-(Trifluoromethvl)Propane with Olah's Reagent

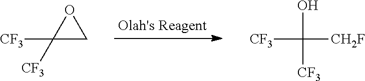

2,3-epoxy-1,1,1- rifluoro-2-(trifluoromethyl)propane was ring opened using the following procedure:
A 100 ml Hastalloy C pressure reactor was charged with Olah's reagent (70% HF:Pyridine, 16.5 g).
After sealing, the contents of the reactor were cooled to 20° C. with stirring.
2,3-epoxy-1,1,1-trifluoro-2-(trifluoromethyl)propane (10 g) was then added.
After this addition was complete the reaction mixture was heated to 50° C. and stirred for 160 hours.
After 160 hours the reaction mixture was quenched with ice and saturated sodium chloride solution (22 ml) added.
The product was extracted from this mixture with diethyl ether.
The diethyl ether extracts were combined, washed with saturated potassium bicarbonate solution and then water before being dried over anhydrous sodium sulphate. The identity of the product was confirmed by NMR spectroscopy.

### Example 3: General Method for the Preparation of Methyl Ethers

The alcohol prepared in Example 1a and Examples 1b/1c, as described above was added to an aqueous solution comprising 20% NaOH and containing 2% tetra-n-butyl ammonium bromide (TBAB) at 0-5° C. A small excess of dimethyl sulfate was then added to this mixture with stirring. When the addition was complete, the reaction was stirred for 1 hour and allowed to warm to room temperature. The product was then recovered by distillation, dried over anhydrous MgSO₄ and then redistilled over CaH₂ to remove impurities and final traces of water.

Using this method, the two methyl ethers below were prepared:

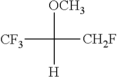

Ether A: ¹⁹F NMR spectrum shows characteristic signals as follows
CF₃ group=−76.28, dd, ³J_{HF}≈⁴J_{FF}=6.6 Hz
CFH₂ group=−235.21, tdq, ²JHF=46.4 Hz, ³JHF=17.9 Hz, ⁴JFF=6.7 Hz

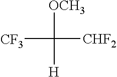

Ether B: ¹⁹F NMR spectrum shows characteristic signals as follows
CF₃ group=−75.31, dt, ³J_{HF}≈J_{FF}=7.7 Hz
CF₂H group −127.91-−130.55, m

### Example 4: Method for the Preparation of Electrolyte Formulations

Ethers A and B were used to prepare sample electrolyte formulations comprising:
Methyl ether A or B
Co-solvent—Ethylene carbonate
Conducting salt—Lithium hexafluorophosphate or lithium bis(fluorosulphonyl)imide (LiFSI)

Solutions were prepared comprising a 50:50 mix of the ether and co-solvent containing 1 M of a conducting salt. These solutions were found to comprise a single phase and be clear.

### FIGURES

The Figures illustrates the results of various spectroscopic analytical techniques carried out on some of the reaction products from the Examples.

FIG. 1 shows a ¹⁹F NMR spectrum of the reaction product of 2,3-epoxyl,1,1-trifluoropropane (TFPO) with Olah's reagent.

FIG. 2 shows a ¹⁹F NMR spectrum of the reaction product of 2,3-epoxy-1,1,1,3-tetrafluoropropane ring opening with Olah's reagent.

FIG. 2a shows a proton coupled (and FIG. 2b a proton decoupled) ¹⁹F NMR spectrum of the reaction product of 2,3-epoxy-1,1,1,3-tetrafluoropropane ring opening with Olah's reagent.

FIG. 3 shows a ¹⁹F NMR spectrum of the reaction product of 2,3-epoxy-1,1,1-trifluoro-2-(trifluoromethyl)propane) ring opening with Olah's reagent.

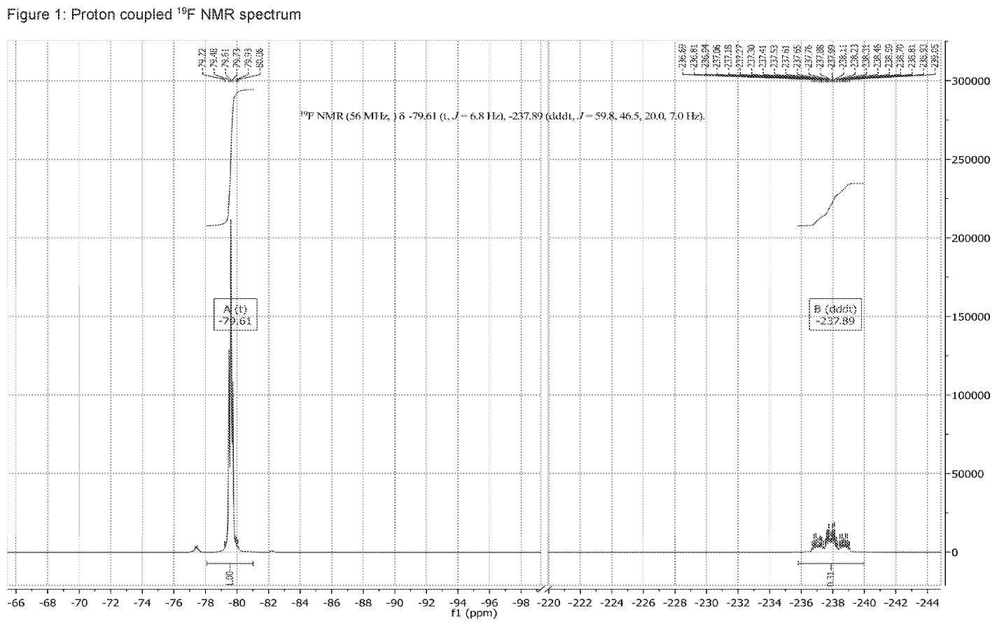

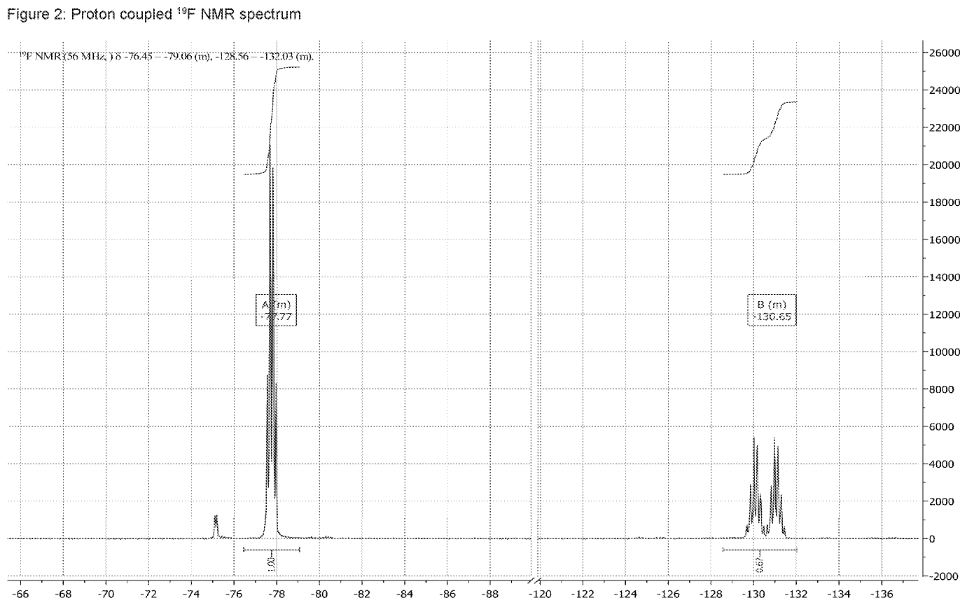

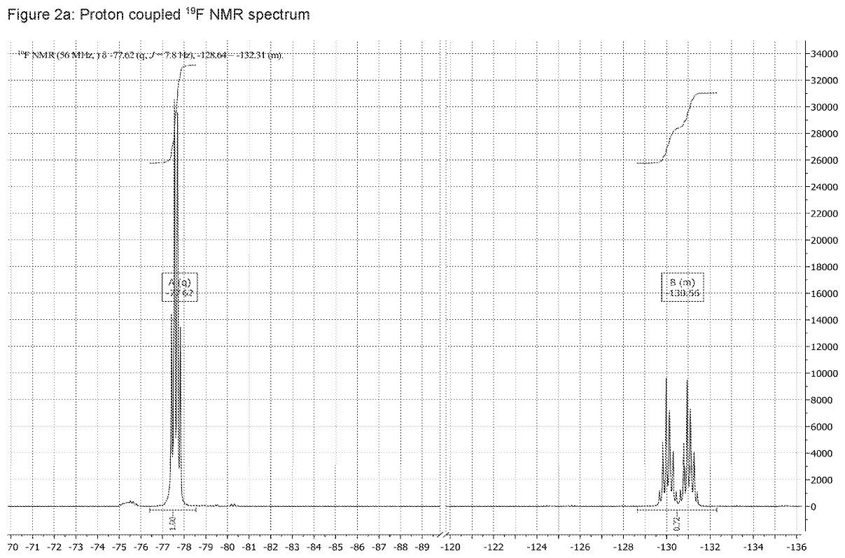

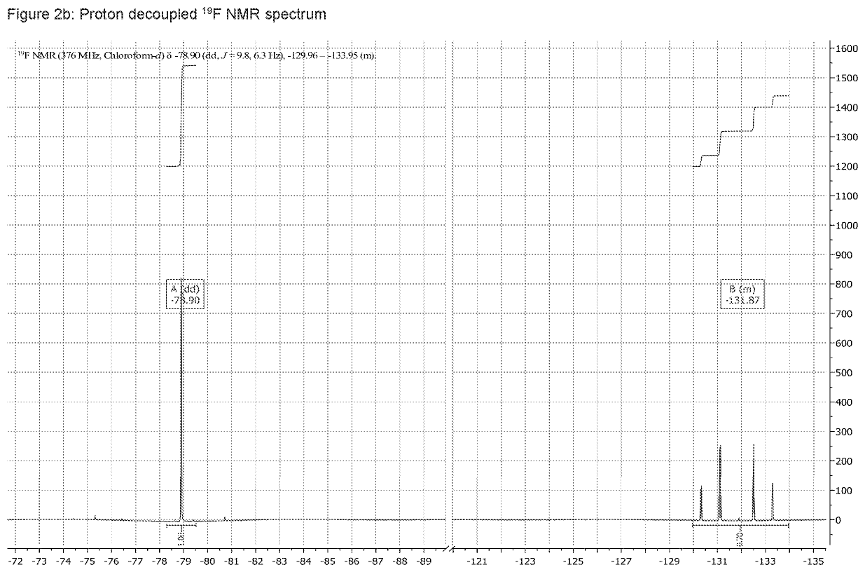

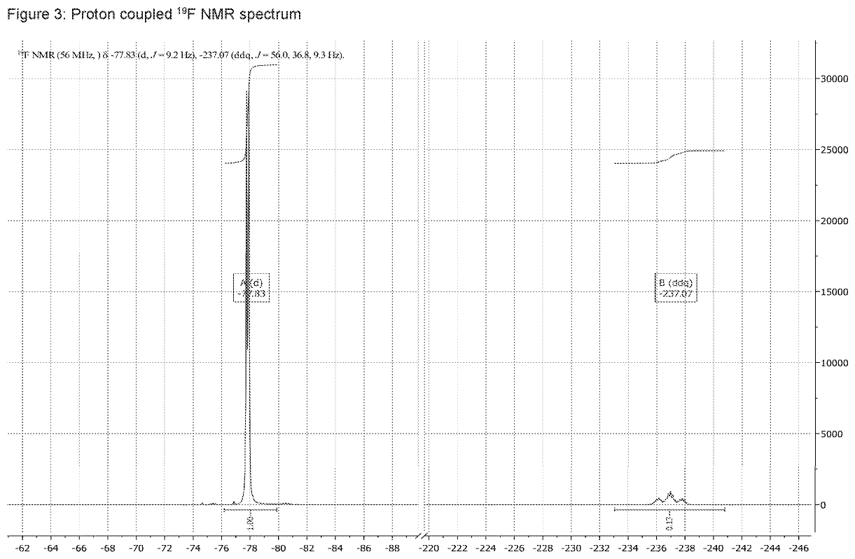

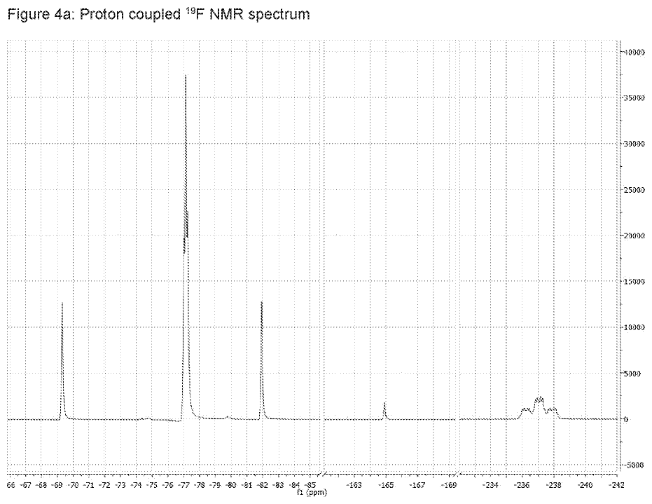

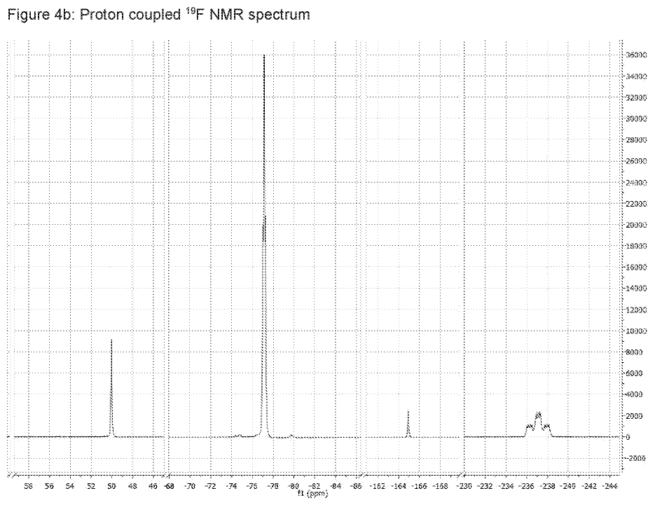

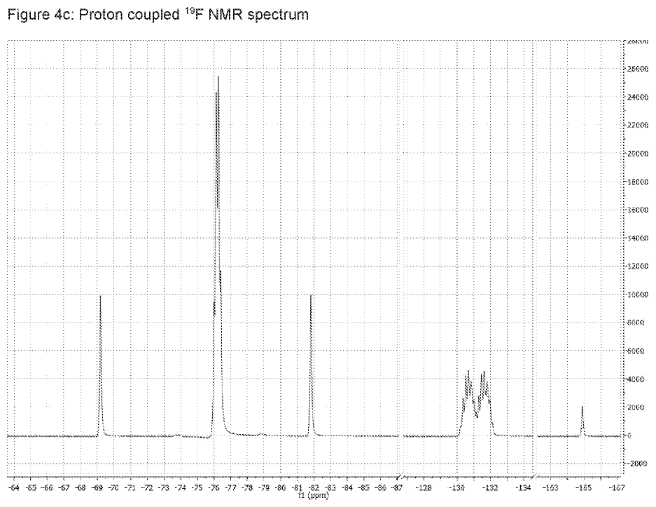

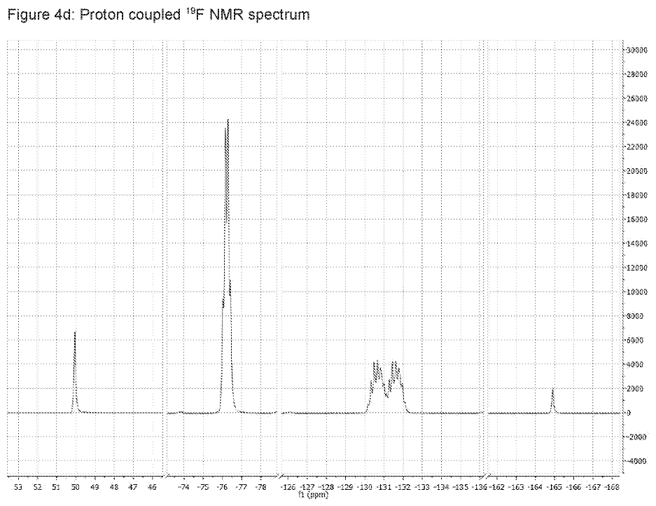

FIG. 4a-d shows a ¹⁹F NMR spectrum of:
a. Ether A, ethylene carbonate and LiPF₆
b. Ether A, ethylene carbonate and LiFSI
c. Ether B, ethylene carbonate and LiPF₆
d. Ether B, ethylene carbonate and LiFSI

1. A method for preparing a nonaqueous battery electrolyte formulation comprising combining a metal ion and a compound of Formula 1 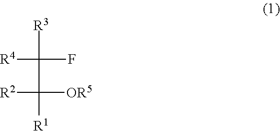
wherein R¹, R², R³, R⁴ are independently selected from the group comprising H, F, Cl, Br, I, CF₃, alkyl, fluoroalkyl, haloalkyl and R⁵ is independently selected from the group CF₃, alkyl, fluoroalkyl, perfluoroalkyl, haloalkyl perfluorohaloalkyl.

2. The method according to claim 1, wherein R⁵ is methyl, and preferably R¹ and R² are CF₃ and R³ and R⁴ are H; or wherein R⁵ is methyl, and preferably R¹ is CF₃, R² is H, one of R³ and R⁴ is F; or wherein R⁵ is methyl, and preferably R¹ is CF₃, R² is H, and R³ and R⁴ are H.

3. The method according to claim 1, wherein the formulation comprises a metal electrolyte salt, present in an amount of 0.1 to 90 wt percent relative to the total mass of the nonaqueous electrolyte formulation.

4. The method according to claim 3, wherein the metal salt is a salt of lithium, sodium, magnesium, calcium, lead, zinc or nickel or quaternary ammonium.

5. The method according to claim 4, wherein the metal salt is a salt of lithium selected from the group comprising lithium hexafluorophosphate (LiPF₆), lithium tetrafluoroborate (LiBF₄), lithium perchlorate (LiClO₄), lithium triflate (LiSO₃CF₃), lithium bis(fluorosulfonyl)imide (LiFSI, Li(FSO₂)₂N) and lithium bis(trifluoromethanesulfonyl)imide (LiTFSI, Li(CF₃SO₂)₂N) or tetraethylammonium tetrafluoroborate.

6. The method according to claim 1, wherein the formulation comprises one or more solvents in an amount of from 0.1 wt percent to 99.9 wt percent of the liquid component of the formulation.

7. The method according to claim 6, wherein the one or more solvent is selected from the group comprising fluoroethylene carbonate (FEC), propylene carbonate (PC) or ethylene carbonate, dimethoxyethane, thionyl chloride, dioxolane or acetonitrile.

8. The method according to claim 1, wherein the battery is a secondary battery, the negative electrode is lithium metal and the electrolyte comprises a compound of Formula 1, dimethoxyethane, and lithium bis(fluorosulfonyl) imide and/or lithium bis(trifluoromethanesulfonyl) imide.

9. A battery electrolyte formulation comprising a metal ion and a compound of Formula 1: 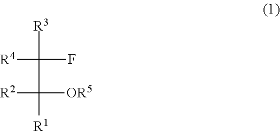
wherein R¹, R², R³, R⁴ are independently selected from the group comprising H, F, Cl, Br, I, CF₃, alkyl, fluoroalkyl, haloalkyl and R⁵ is independently selected from the group CF₃, alkyl, fluoroalkyl, perfluoroalkyl, haloalkyl perfluorohaloalkyl.

10. A formulation comprising a metal ion and a compound of Formula 1, optionally in combination with a solvent: 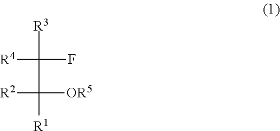
wherein R¹, R², R³, R⁴ are independently selected from the group comprising H, F, Cl, Br, I, CF₃, alkyl, fluoroalkyl, haloalkyl and R⁵ is independently selected from the group CF₃, alkyl, fluoroalkyl, perfluoroalkyl, haloalkyl perfluorohaloalkyl.

11. A battery comprising a battery electrolyte formulation comprising a metal ion and a compound of Formula 1: 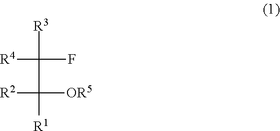
wherein R¹, R², R³, R⁴ are independently selected from the group comprising H, F, Cl, Br, I, CF₃, alkyl, fluoroalkyl, haloalkyl and R⁵ is independently selected from the group CF₃, alkyl, fluoroalkyl, perfluoroalkyl, haloalkyl perfluorohaloalkyl.

12. The formulation according to claim 10, wherein the formulation comprises a metal electrolyte salt, present in an amount of 0.1 to 90 wt percent relative to the total mass of the formulation.

13. The formulation according to claim 12, wherein the metal salt is a salt of lithium, sodium, magnesium, calcium, lead, zinc or nickel.

14. The formulation according to claim 13, wherein the metal salt is a salt of salt of lithium selected from the group comprising lithium hexafluorophosphate (LiPF₆), lithium perchlorate (LiClO₄), lithium tetrafluoroborate (LiBF₄), lithium triflate (LiSO₃CF₃), lithium bis(fluorosulfonyl)imide (LiFSI, Li(FSO₂)₂N) and lithium bis(trifluoromethanesulfonyl)imide (LiTFSI, Li(CF₃SO₂)₂N) or tetraethylammonium tetrafluoroborate.

15. The formulation according to claim 10, wherein the formulation comprises one or more solvents in an amount of from 0.1 wt percent to 99.9 wt percent of the liquid component of the formulation.

16. The formulation according to claim 15, wherein the one or more solvent is selected from the group comprising fluoroethylene carbonate (FEC), propylene carbonate (PC) and ethylene carbonate (EC), dimethoxyethane, thionyl chloride, dioxolane or acetonitrile.

17. A method of reducing the flammability of a battery and/or a battery electrolyte comprising adding to the battery and/or the battery electrolyte a formulation comprising a metal ion and a compound of Formula 1, according to claim 10

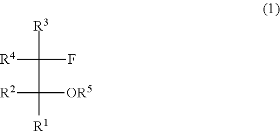

18. A method of powering an article comprising electrically coupling the article to a battery comprising a battery electrolyte formulation comprising a metal ion and a compound of Formula 1, according to claim 10

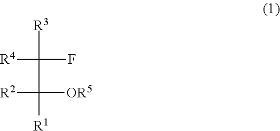

19. A method of retrofitting a battery electrolyte formulation comprising either (a) at least partially replacing the battery electrolyte with a battery electrolyte formulation comprising a formulation comprising a metal ion and a compound of Formula 1 and/or (b) supplementing the battery electrolyte with a battery electrolyte formulation comprising a formulation comprising a metal ion and a compound of Formula 1: 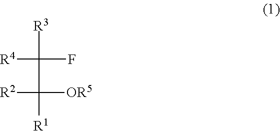
wherein R¹, R², R³, R⁴ are independently selected from the group comprising H, F, Cl, Br, I, CF₃, alkyl, fluoroalkyl, haloalkyl and R⁵ is independently selected from the group CF₃, alkyl, fluoroalkyl, perfluoroalkyl, haloalkyl perfluorohaloalkyl.

20. A method of preparing a battery electrolyte formulation comprising mixing a formulation comprising a metal ion and a compound of Formula 1 according to claim 10 with ethylene, propylene or fluoroethylene carbonate and lithium hexafluorophosphate.

21. A method of improving battery capacity/charge transfer within a battery/battery life/etc comprising adding to the battery a formulation comprising a metal ion and a compound of Formula 1 according to claim 10.

22. The method according to claim 17, wherein the formulation comprises a metal electrolyte salt, present in an amount of 0.1 to 90 wt percent relative to the total mass of the nonaqueous electrolyte formulation.

23. The method according to claim 22, wherein the metal salt is a salt of lithium, sodium, magnesium, calcium, lead, zinc, ammonium or nickel.

24. The method according to claim 23, wherein the metal salt is a salt of lithium selected from the group comprising lithium hexafluorophosphate (LiPF₆), lithium perchlorate (LiClO₄), lithium tetrafluoroborate (LiBF₄), lithium triflate (LiSO₃CF₃), lithium bis(fluorosulfonyl)imide (LiFSI, Li(FSO₂)₂N) and lithium bis(trifluoromethanesulfonyl)imide (LiTFSI, Li(CF₃SO₂)₂N), or tetraethylammonium tetrafluoroborate.

25. The method according to claim 17, wherein the formulation comprises additional solvents in an amount of from 0.1 wt percent to 99.9 wt percent of the liquid component of the formulation.

26. The method according to claim 25, wherein the additional solvent is selected from the group comprising fluoroethylene carbonate (FEC), propylene carbonate (PC) and ethylene carbonate (EC), dimethoxyethane, thionyl chloride, dioxolane or acetonitrile.
